(19) United States
(12) Patent Application Publication
(10) Pub. No.: US 2011/0314173 A1
(43) Pub. Date: Dec. 22, 2011

(54) SYSTEM AND METHOD FOR MIRRORING A PORTABLE DEVICE OVER REMOTE DISPLAY

(75) Inventor: CHUNGNAN LYU, Saratoga, CA (US)

(73) Assignee: RAYCOMM TECHNOLOGIES, INC., Grand Cayman (KY)

(21) Appl. No.: 13/050,573

(22) Filed: Mar. 17, 2011

Related U.S. Application Data
(60) Provisional application No. 61/397,637, filed on Jun. 16, 2010.

(51) Int. Cl. G06F 15/16

(52) U.S. Cl. 709/231

(57) ABSTRACT

A system for mirroring a portable device over a remote display is disclosed herein and includes a portable device, a router and a remote display. The portable device includes a mirror program. The router is configured to download and decode a plurality of video streams in accordance with a request of the mirror program. The remote display is configured to display the plurality of video streams, which are decoded by the router.

### BACKGROUND OF THE INVENTION

1. Field of the Invention

The present invention is related to a system and method for mirroring a portable device over a remote display including but not limited to content chosen from the Internet, and more particularly to a system and method for mirroring a portable device over a remote display by a smart router (including but not limited to content chosen from the Internet by the portable device).

2. Description of the Prior Art

Portable devices, such as smart phones, personal digital assistant (PDA) devices, laptops and so on, are so popular in our normal life. Because the portable devices are easy to carry, people can use them to connect to the Internet anywhere. The portable device is portable because of its light weight and its tiny monitor with small screen size. However, when people would like to watch video, including those chosen from the Internet, on the portable device, they have to watch it on the tiny monitor.

Further, if people wanted to transfer the video from the portable device to a large scale display prior to the present invention, their choices were limited.

In a first conventional method, the large scale display included a player or a decoder to decode the video stream so as to play the video on the large scale display. However, most of the large scale displays do not include various-format video stream decoders, and the video streams are not able to be decoded and displayed on those large scale displays.

A second conventional method is to use the portable device to decode the stream first and transfer the stream to the large scale display. However, the decoded HD (high definition) stream bandwidth requirement is so prohibitively high that it is difficult if not impossible be transferred by current mobile telecommunication (such as 3rd Generation telecommunication) technology.

Accordingly, a need continues to exist for a system and method for mirroring a portable device over remote display to play clear and high definition images/videos on a large scale display using existing 802.11 b/g/n WIFI technologies. The images/videos can be locally stored image or chosen from the Internet.

### SUMMARY OF THE INVENTION

In view of foregoing, one object of the present invention is to provide a system to display high definition (HD) video streams on a portable device and a remote display in a synchronized manner.

According to one embodiment, a system for mirroring a portable device over a remote display includes a portable device, a router and a remote display. The portable device includes a mirror program. The router is configured to download and decode a plurality of video streams in accordance with a request by the mirror program. The remote display is configured to display the plurality of video streams decoded by the router.

According to another embodiment, a method for mirroring a portable device over a remote display includes the following steps: the step of activating a mirror program in a portable device; the step of choosing a video program and sending a display request to a router by the mirror program; the step of downloading a plurality of video streams; the step of decoding the plurality of video streams by the router; the step of transmitting the plurality of video streams to a remote display; and the step of displaying the plurality of video streams on the remote display.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a view illustrating a system for mirroring a portable device over remote display;

FIG. 2A is a view illustrating the router 104 in the present invention;

FIG. 2B is a schematic block diagram illustrating several components in the router 104; and

FIG. 3 is a flow chart illustrating a method for mirroring a portable device over remote display.

### DESCRIPTION OF THE PREFERRED EMBODIMENT

The following detailed description of the present invention describes a system and method for mirroring a portable device over remote display thereof necessary to provide an understanding of the present invention, but does not cover a complete structure composition and the operating theory. The portions relating to the conventional techniques are briefly described, and the parts of the drawings are not proportionally drafted. While embodiments are discussed, it is not intended to limit the scope of the present invention. Except expressly restricting the amount of the components, it is appreciated that the quantity of the disclosed components may be greater than that disclosed.

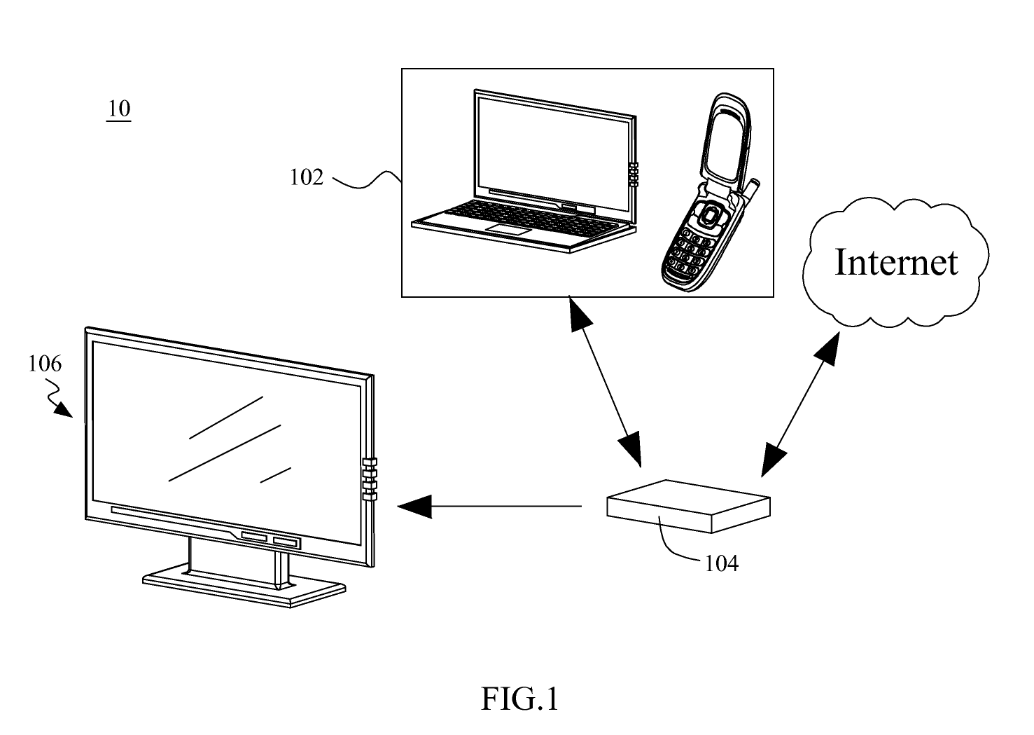

FIG. 1 is a view illustrating a system 10 for mirroring a portable device over a remote display. The system 10 includes a portable device 102, a router 104 and a display 106. The portable device 102 includes, but is not limited to, a smart phone, a personal digital assistant (PDA) device, etc., having Internet capabilities through a WIFI connection via a typical WIFI LAN (local area network) router. The router 104 is connected to the portable device 102 via wireless communications (such as WIFI or BLUETOOTH) or wired communications (such as Ethernet). The router 104 is also connected to the Internet via telephone line or cable line. The display 106 is connected to the router 104 via wired communications (such as HDMI (High-Definition Multimedia Interface) or any other video cables) or wireless communications (such as BLUETOOTH, 802.11 b/g/n WIFI technology, etc.). The router 104 includes a high definition (HD) video stream decoder configured to decode a HD video stream mostly received over the Internet or stored at the local drive in the portable device 102 or the router 104. The portable device 102 includes a mirror program to enable the router 104 to download the HD video stream and decode the HD video stream. The mirror program is software installed in the portable device 102 or firmware embedded in the portable device 102 and the user can activate the mirror program by launching the software or by pushing a button on the portable device 102. When the user uses the portable device 102 to find a video from the Internet or stored at the local drive and would like to watch it, the user can launch the mirror program on the portable device 102 to enable the router 104 to download and decode the video stream. Subsequently, the decoded video stream is transmitted from the router 104 to the display 106 via wired or wireless communications. Therefore, the video that the user likes can be played on the display 106 with a large scale display panel. Because the display 106 is not directly connected to the portable device 102, the display 106 is also named as a remote display.

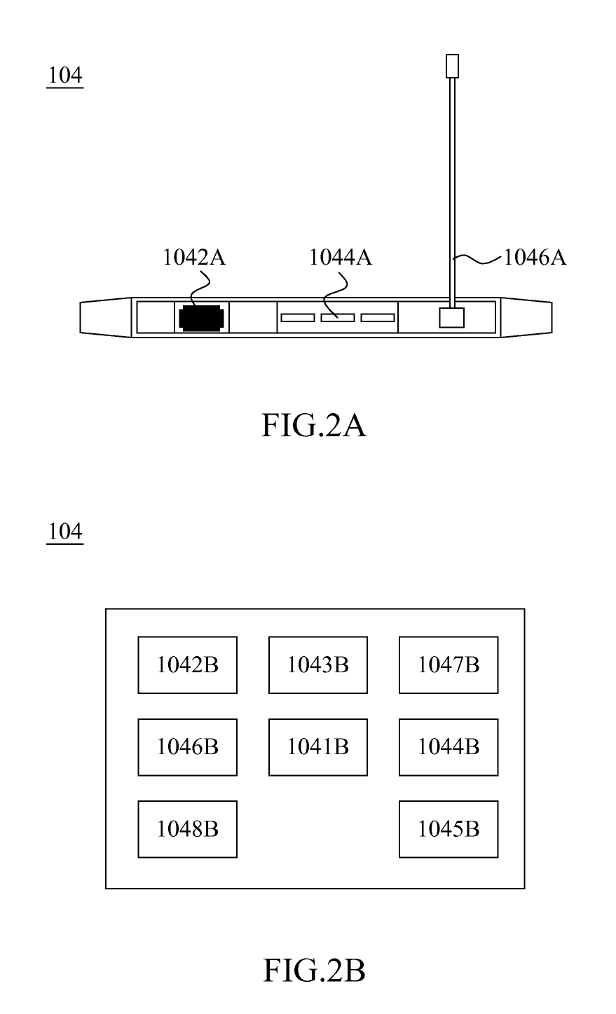

FIG. 2A is a view illustrating the router 104 in the present invention. As shown in FIG. 2A, there are several different interfaces on the router 104. For example, the router 104 includes but is not limited to a video output port 1042A, several Ethernet ports 1044A and a WIFI antenna 1046A. The video output port 1042A (such as an HDMI port) is configured to connect to the display 106. The Ethernet ports 1044A are configured to connect to the Internet, other electronic devices or the display 106 with an Ethernet connection. The WIFI antenna 1046A is configured to connect to the portable device 102, other electronic devices or the display 106 with a WIFI connection (such as 802.11 b/g/n WIFI technology). Accordingly, the router 104 in the present invention can decode the video stream downloaded from the Internet or stored in the local drive and transmit the video stream to the display 106 through the video port 1042A, the Ethernet port 1044A or the WIFI antenna 1046A. Therefore, any display with a video port (such as an HDMI port), an Ethernet port or a WIFI connection could be the display 106 in the present invention.

FIG. 2B is a schematic block diagram illustrating several components in the router 104. As shown in FIG. 2B, the router 104 includes but is not limited to a controller 1041B, a DRAM (dynamic random access memory) 1042B, a NOR/NAND memory 1043B, a WIFI component 1044B, an Ethernet Switch component 1045B, an Infrared communication component 1046B, a video component 1047B and a JTAG 1048B. The controller 1041B of the router 104 in the present invention can not only control the dataflow but also decodes the video stream. Therefore, the video stream can be decoded in the router 104 and then transmitted to any display without an HD video decoder. Because the functions in the rest of the components of the router 104 are the same as a conventional router, the detail descriptions of those components are omitted herein.

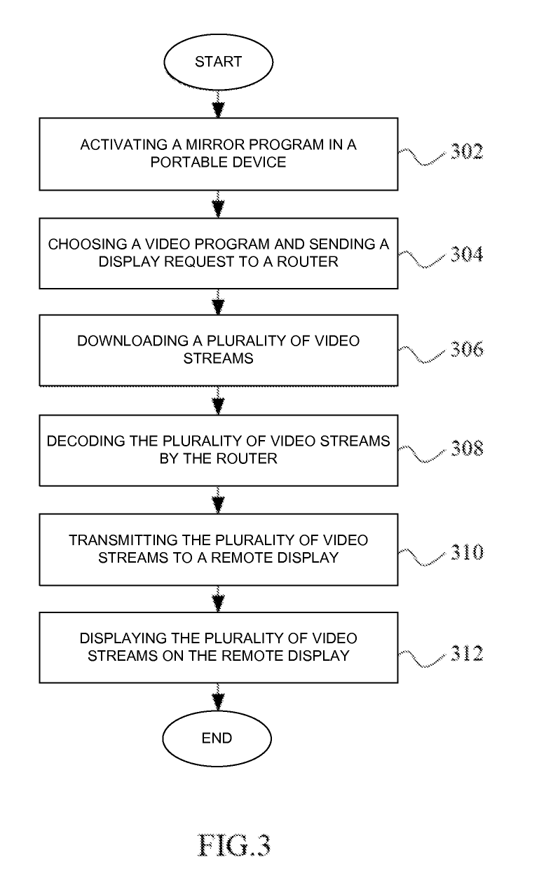

FIG. 3 is a flow chart illustrating a method for mirroring a portable device over remote display. As shown in FIG. 3, in step 302, a mirror program is activated in a portable device. The mirror program is software installed in the portable device or firmware embedded in the portable device. The portable device includes but is not limited to a notebook, a tablet, a cellular phone, a PDA and so on. Any mobile device with an Internet connection could be the portable device in the present invention. In step 304, a video program is chosen and a display request is sent to a router by the mirror program. In step 306, the router starts to download the video stream, and the router decodes the video stream in step 308. In step 310, the video stream, which is decoded, is transmitted to a remote display. In step 312, the video stream is displayed on the remote display. It should be noted that the video stream in the present invention can be stored in the portable device, an electronic device or a local storage drive which is directly connected to the router. Further, the video streams in the present invention are High Definition video streams. The remote display is not necessarily directly connected to the portable device.

Although specific embodiments have been illustrated and described, it will be appreciated by those skilled in the art that various modifications may be made without departing from the scope of the present invention, which is intended to be limited solely by the appended claims.

What is claimed is:

1. A system for mirroring a portable device over a remote display, comprising:
a portable device including a mirror program;
a router configured to download and decode a plurality of video streams in accordance with a request by the mirror program; and
a remote display configured to display the plurality of video streams, which are decoded by the router.

2. The system of claim 1, wherein the plurality of video streams are downloaded from the Internet to the router.

3. The system of claim 1, wherein the router includes a controller to decode the plurality of video streams.

4. The system of claim 1, wherein the router includes a video port configured to connect to the remote display.

5. The system of claim 1, wherein the router is connected to the remote display by an 802.11 b/g/n WIFI connection or an Ethernet port.

6. The system of claim 1, wherein the portable device includes an 802.11 b/g/n WIFI connection.

7. The system of claim 1, wherein the plurality of video streams are High Definition video streams.

8. The system of claim 1, wherein the plurality of video streams are downloaded from a local drive to the router.

9. The system of claim 1, wherein the local drive is installed in the portable device or the router.

10. A method for mirroring a portable device over a remote display, comprising:
activating a mirror program in a portable device;
choosing a video program and sending a display request to a router by the mirror program;
downloading a plurality of video streams;
decoding the plurality of video streams by the router;
transmitting the plurality of video streams to a remote display; and
displaying the plurality of video streams on the remote display.

11. The method of claim 10, wherein the mirror program is activated by launching software in the portable device.

12. The method of claim 10, wherein the mirror program is activated by pushing a button in the portable device.

13. The method of claim 10, wherein the downloading step is to download the plurality of video streams from the Internet.

14. The method of claim 10, wherein the downloading step is to download the plurality of video streams from the portable device.

15. The method of claim 10, wherein the download step is to download a plurality of high definition video streams.

16. The method of claim 10, wherein the transmitting step is to transmit the plurality of video streams via wire.

17. The method of claim 10, wherein the transmitting step is to transmit the plurality of video streams via wireless.
